(19) United States
(12) Patent Application Publication
(10) Pub. No.: US 2006/0080844 A1
(43) Pub. Date: Apr. 20, 2006

(54) Device and process for generating surface channels in plate-shaped workpieces

(76) Inventor: August Bauhuber, Pocking (DE)

Correspondence Address: ST. ONGE STEWARD JOHNSTON & REENS, LLC, 986 BEDFORD STREET, STAMFORD, CT, 06905-5619, US

(21) Appl. No.: 11/252,839

(22) Filed: Oct. 18, 2005

(30) Foreign Application Priority Data
Oct. 18, 2004 (DE) 10 2004 050 635.3

(51) Int. Cl. B26B 7/00

(52) U.S. Cl. 30/272.1

(57) ABSTRACT

A device and a process for generating surface channels in plate-shaped workpieces are disclosed, wherein a tool is used which comprises a fastening section, whereon a tool receptacle is provided for fastening the tool to an oscillatory drive. The tool comprises a guiding section for guiding the tool along a surface of the workpiece, and further comprises a hollow knife protruding from the guiding section and having at least one cutting edge, wherein the guiding section is configured plate-shaped and is connected rigidly with first and second ends of the hollow knife.

### RELATED APPLICATION

This application claims priority of German Patent Application No. 10 2004 050 635.3 filed on Oct. 18, 2004.

### FIELD OF THE INVENTION

The present invention relates to a tool for generating surface channels in plate-shaped workpieces, such as panels made of hard foam, mineral fibers or of styrene polymer, comprising a fastening section whereon a tool receptacle for mounting to an oscillatory drive is provided, further comprising a guiding section for guiding along a surface of the workpiece, and further comprising a hollow knife protruding from the guiding section and having at least one cutting edge.

### BACKGROUND OF THE INVENTION

The invention further relates to a device and a process for generating surface channels in plate-shaped work-pieces using such a tool.

A tool as well as a device and a process of the kind mentioned at the outset are known from U.S. Pat. No. 5,231,910.

According to this, surface channels can be generated in plates using an oscillatingly driven cutting tool comprising a mounting section and a guiding section attached thereto, wherein a hollow knife having a roughly U-shaped cross-section is connected at one end thereof with the guiding section and is formed unitary therewith.

The oscillatingly driven hollow knife is guided through the plate to be cut in a feed direction that is roughly tangential to the drive shaft of the oscillatory drive, so that the surface channel is cut out. Herein the cutting knife is guided by placing its guiding section along the surface of the plate.

In an alternative design of the known cutting knife, two cutouts are provided in the guiding section into which a U-shaped cutting knife can be inserted with its two legs and can be fixed thereon aided by a spring force.

Although such a tool can basically be used for generating surface channels in plate-shaped workpieces, it has been found that the cutting tools are not sufficiently stable to withstand the loads acting thereon, in particular when the plates are made of a relatively hard material, such as hard foam, and are possibly equipped with a reinforcement. Thus, the known tool usually breaks even after a short time of usage.

### SUMMARY OF THE INVENTION

Thus, it is a first object of the invention to disclose an improved tool for generating surface channels in plate-shaped workpieces having a high durability even when cutting hard or tough material.

It is a second object of the invention to disclose an improved to disclose an improved device using an oscillatingly driven tool for generating surface channels in plate-shaped workpieces, wherein the tool has a high durability even when cutting hard or tough material.

It is a third object of the invention to disclose an improved tool for generating surface channels in plate-shaped workpieces having a reduced risk of breakage even when cutting hard or tough material.

It is a forth object of the invention to disclose an improved process for generating surface channels in plate-shaped workpieces using an oscillatingly driven tool having a high durability even when cutting hard or tough material.

According to the invention these and other objects are achieved by a tool for generating surface channels in plate-shaped workpieces, such as in plates made of hard foam, mineral fibers or styrene polymer, having a mounting section whereon a tool receptacle for mounting on an oscillatory drive is provided, further comprising a guiding section for guiding along a surface of the workpiece, and further comprising a hollow knife protruding from the guiding section and having at least one cutting edge, wherein the guiding section is formed plate-shaped and is connected rigidly with a first end and with a second end of the hollow knife.

Thus, the object of the invention is fully achieved.

By the plate-shaped design of the guiding section in connection with the rigid mounting of the hollow knife with its first and second end to the guiding section, a particularly high stability of the tool is ensured. Thus, it can be worked on very hard or tough material using high forces without encountering a fast breaking of the tool. Also due to the rigid connection of the hollow knife with its first and second end to the plate-shaped guiding section, the tool can be moved in feed direction with high force.

In particular, a tool according to the invention can also be used for generating laying channels in hard foam carrier panels, such as necessary when installing a floor heating having a low construction height and a good heat transfer.

According to this, it is intended to make the laying channel for heating pipes formed in a rigid foam carrier panel with a width larger than the diameter of the heating pipes to be placed therein, and to arrange the laying channel in a wavy pattern, i.e. a line meandering about a laying centerline. The heating pipe in the laying channel then comes to alternately contact opposite side walls of the laying channel, but is otherwise freely disposed in the laying channel. The heat can then be freely conducted from the heat-insulating rigid foam of the carrier panel toward the top and into the floor. The free space around the heating pipes is conveniently filled with a grouting compound or the like having good heat-conducting properties.

For reasons of stability, a carrier panel with reinforcements provided on its top and its bottom is preferred as rigid foam carrier panel. Such reinforcement consists of a glass fiber weave embedded between a contact mortar layer (facing the rigid foam) and a covering mortar layer. Such a rigid foam carrier panel is commercially available under the trade name Lux Elements®.

The laying channel for the heating pipes preferably has a width of at least 110 to 150% of the diameter of the heating pipe to be placed in it, and the depth of the laying channel is, preferably, in a range of between 100 and 120% of the diameter of the heating pipe. Relative to the top of the panel, the laying channel conveniently exhibits a slight undercut which facilitates the laying operation in that it fixes the heating pipe more effectively in case stresses should occur so that it will not jump off the channel.

Preferably, one or more printed grid patterns of between 5 and 30 cm are printed on the upper surface of the rigid foam carrier panel, which considerably facilitates the operation of cutting in the laying channels.

Although the rigid foam carrier panel may basically be pre-fabricated industrially, with the laying channel already formed in it, for the most applications a customized generation of the laying channels using the tool according to the invention is preferred.

The tool according to the invention comprises a hollow knife having the shape of the cross-sectional contour of the laying channel to be cut, the knife being provided on the bottom surface of a sliding plate intended to slide along the panel surface when cutting in the channel. The tool holder serves for connecting the tool with a commercially available hand-held electric oscillating tool having an output shaft which is oscillatingly driven about its longitudinal axis. The cutting edge thus is oscillatingly driven, whereby the hard foam is cut. Such an oscillatory drive serves to drive the tool with a rotary oscillating movement at a high frequency which is usually between about 5,000 and 25,000 oscillations per minute and having a small pivot angle which is usually between 0.5 and 5°.

The amplitude of the oscillating movement must be adapted to the material of the carrier panel. The material removed can then be easily lifted off the channel, with a minimum of contamination and dust being produced.

The guiding section being designed as the sliding plate can be moved on the surface of the workpiece to be worked like a skid, the hollow knife being constantly held in the proper position relative to the workpiece surface.

Marks provided on the forward end of the sliding plate at a spacing corresponding to the amplitude of the desired meander pattern or the amplitude of the wavy line serve as indication for the operator of the areas within which the wavy laying channel is to be cut into the carrier panel.

For working rigid foam carrier panels, which are provided with a reinforcement on their upper surfaces, the hollow knife is provided, in areas adjacent the sliding plate, with hardened or hard alloy cutting edges capable of destroying the reinforcements and the hard mortar layer before the cutting edge as such cuts into the rigid foam.

According to an advantageous development of the invention, the hollow knife is connected with the guiding section by solid material, wherein preferably the first and second end of the hollow knife are welded to the guiding section.

Thereby a particularly durable and reliable design of the tool is ensured, whereby the risk of breakage is reduced even after long usage.

Since the hollow knife is preferably designed in the shape of the cross-section of the surface channel to be cut, the hollow knife may have at least partially a bent or linear cutting edge, in particular, the cutting edge may have an approximately partially circular, an approximately rectangular or an approximately V-shaped cutting edge.

According to a further development of the invention, the guiding section comprises a cutout through which the hollow knife is inserted with its first and second end and is secured to the guiding section on the side opposite to the hollow knife.

In this way, a completely flat surface of the guiding section can be reached together with a high stability of the tool.

According to an alternative design, the hollow knife may be secured to the guiding section on the side facing it.

In this way, cutouts within the guiding section can be avoided, this leading to a particularly high stability of the hollow knife.

According to a further design of the invention, the cutting edge of the hollow knife and/or an additional cutter which, preferably, is arranged at the very first within the feed direction, are coated with a wear-off protective layer which may comprise hard alloy particles, diamond particles or boron carbide particles or which may be designed in metal spraying technique.

In this way, an even higher durability of the tool according to the invention can be reached.

According to a further development of the invention, the tool receptacle is configured as a mounting opening defining a longitudinal axis about which the tool can be oscilatingly driven, wherein the hollow knife has a feed direction arranged at an angle to the longitudinal axis, and preferably extending radially to the longitudinal axis.

When using such an arrangement of the tool relative to the oscillatory drive, the tool can practically be pushed through the surface of the workpiece to be processed, so that particularly high forces can be transferred. This is advantageous in particular when processing very hard or tough materials.

According to an alternative design of the invention, the tool receptacle is configured as a mounting opening defining a longitudinal axis, about which the tool is oscillatingly driven, wherein the hollow knife defines a feed direction extending in parallel to a tangent of the longitudinal axis.

According to this design, the tool is not “pushed” through the workpiece, instead may be “drawn” through the work piece using the oscillatory drive, to generate the surface channels. In this way, the oscillatory motion itself facilitates the cutting effect, since the oscillatory motion goes back and forth practically in the feed direction. Thus, the workpiece may partially be processed using a smaller force than encountered according to the first embodiment of the invention.

According to a process according to the invention, the hollow knife having a cutting edge protruding from the guiding section is oscillatingly driven about a longitudinal axis and is advanced through the workpiece in a feed direction extending at an angle to the longitudinal axis, preferably radially to the longitudinal axis, whereby the tool is guided with its guiding section along a surface of the workpiece.

Thus, by a pushing movement of the tool, a processing of the workpiece using a high force is made possible without the necessity to manually absorb a lever force acting in a radial direction.

It is understood that the features that have been described before and will be explained hereafter may be used not only in the described combination, but also in other combinations, or individually, without leaving the scope and intent of the present invention.

### BRIEF DESCRIPTION OF THE DRAWINGS

Further embodiments and advantages of the invention will now be described in more detail with reference to the drawings in which:

FIG. 1 shows a perspective view of a detail of the rigid foam carrier panel of a floor heating, with the laying channel cut into the panel and the heating pipe installed;

FIG. 2 shows a perspective diagrammatic view of a tool or a supplementary unit for cutting the laying channel into a rigid foam carrier panel;

FIG. 3 shows one example of a cross-sectional contour of the laying channel, with fitted heating pipes of different diameters;

FIG. 4 shows a perspective view of a further embodiment of a tool according to the invention;

FIG. 5 shows a top view of the tool according to FIG. 4;

FIG. 6 shows a front view of the tool according to FIG. 5;

FIG. 7 shows a side-elevational view of the tool according to FIG. 6;

FIG. 8 shows a perspective view of a further embodiment of a tool according to the invention;

FIG. 9 shows a top view of the tool according to FIG. 8;

FIG. 10 shows a front view of the tool according to FIG. 9;

FIG. 11 shows a side-elevational view of the tool according to FIG. 10;

FIG. 12 shows a partial side elevational view of a device according to the invention having a tool mounted on the output shaft of an oscillatory drive; and

FIG. 13 shows a perspective view of a further modification of a tool according to the invention.

### DETAILED DESCRIPTION OF THE PREFERRED EMBODIMENTS

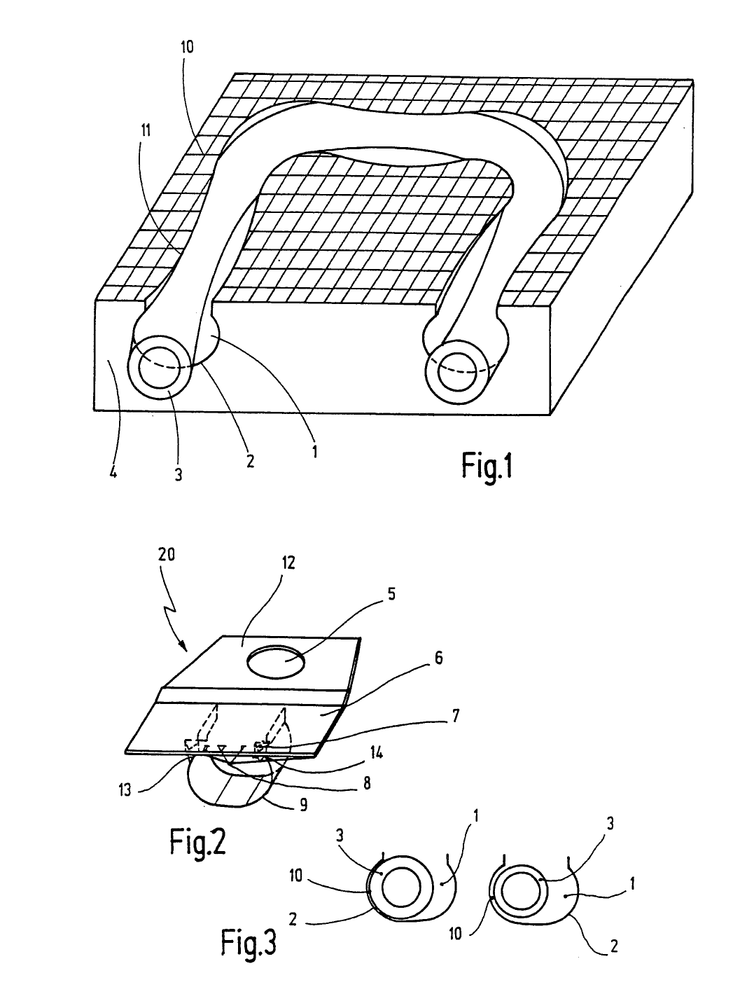

A carrier panel 4 shown in FIG. 1, consisting for example of a polystyrene rigid foam, carries on its upper surface and on its lower surface—not shown—a glass fiber weave reinforcement 11—not visible—embedded between a contact filler layer and a covering mortar layer. A laying channel 1 for a heating pipe 3, which is open toward the top of the panel, is cut into the panel surface through the reinforcement 11. The width of the laying channel 1 is greater than the diameter of the heating pipe 3 to be placed in it. The laying channel 1 is deep enough to accommodate the heating pipe 3 so that it extends substantially flush with the panel surface. The laying channel 1 follows a meandering line about an imaginary laying centerline, or a centerline printed on the panel surface, so that the installed heating pipe 3 will alternately contact opposite side walls of the laying channel 1 in clamping areas 10 whereas it will be free to move in other areas of the laying channel 1. As illustrated in the drawing, the cross-sectional contour 2 of the laying channel 1 exhibits an undercut relative to the panel surface, which facilitates the laying operation.

The points of contact between the heating pipe 3 and the rigid foam carrier panel 4 are only small. The greatest part of the heating pipe 3 is surrounded by free space. That free space is filled up with a filler (not shown) having good heat-conducting properties. The filler transmits the heat to the top whereby efficient heat dissipation into the floor is achieved. The inertia of floor heating systems (heating-up time) known heretofore is not encountered in this case. Instead, the invention allows a quickly responding floor heating with short heating-up times to be realized.

FIG. 2 shows a first embodiment of a tool 20 according to the invention for cutting the laying channel 1 into the rigid foam carrier panel 4. The tool 20 comprises a fastening section 12 having a mounting opening 5 which runs via a bent-off section into the guiding section 6 configured as a sliding plate. A hollow knife 9 (channel cutter) having the form of the cross-sectional contour 2 of the laying channel to be cut is located on the lower surface of a sliding plate 6. The hollow knife 9 is fixed with its two ends 13, 14 rigidly to the sliding plate 6 and is, preferably, welded thereto. The hollow knife 9 consists of stainless steel or a hardened metal and comprises a pre-cutter 7 with hardened or hard-metal cutting edges, arranged in areas neighboring the sliding plate 6, for pre-cutting the reinforcement 11 with the mortar layers. Marks 8 on the forward edge of the sliding plate 6 provide an indication for the operator of the amplitude or magnitude of deflection of the wavy line of the laying channel 1. The tool can be mounted on a commercially available hand-held electric oscillatory drive 42 by means of the mounting opening 5 (cf. FIG. 12).

Thereby the tool 20 is oscillated about the mounting opening 5 at a high frequency of about 5,000 to 25,000 Hz and at a small pivot angle of about 0.5 to 5°.

The described tool enables the operator to cut laying channels into a rigid foam carrier panel in a rational way and gives the operator the possibility to realize creative solutions. Any room is defined by a floor, walls and a ceiling. The rigid foam carrier panel can be used in all the three planes, together with all sorts of other layers on its surfaces. It does not present any problem to install a hot-water heating using the tool in all areas of the floor, the walls, the ceilings and special constructions. Combining installations in different areas is likewise possible. This places the operator in a position to react spontaneously to customer requests and to realize them immediately. Using the tool it is also possible to cut in ducts for trades other than the installation of heating systems, for example hollow channels for electric wiring conduits—although these will not be cut along a wavy line.

The laying method according to the invention will be described hereafter with reference to the renewal and original installation of a bathroom floor, by way of example.

Existing conditions: Old tilework on composite screed topping, overall thickness of the old system: 4.5 cm.

Sequence of operations:
Removal of the old flooring system.
Installation of the rigid foam carrier panel with a thickness of 3 cm in this case, through which operation the floor can be equalized simultaneously, if necessary.
Note: The thicker the rigid foam carrier panel, the larger will be the heat-insulating area between the bottom of the heating pipe and the lower panel surface.
Tracing the arrangement of the heating pipes on the rigid foam carrier panel by consultation with the heating firm. At the points of connection of the heating pipes to the radiators, a piece of the carrier panel is cut out for being installed again after the pipes are in place.
Using the channel cutter, one then cuts out the channel for installation of the heating in a wavy pattern along the marks previously applied. Following the cutting operation, any debris can be lifted off the channel.
Once the slight contaminations have been removed by vacuum, the heating pipe can be installed and connected.
The free spaces surrounding the heating pipe are grouted with liquid filler. A reinforcement is applied over the entire surface; the thickness of the filler layer so applied may be a little greater because the resulting mass helps in transmitting the heat from the heating pipe to the tile.
According to manufacturers' specifications for rigid foam carrier panels, immediate setting and jointing of the tiling is now possible. Alternatively, a sealing sheet with lengthwise and crosswise channels on its lower surface, such as a Schlüter-Ditramatte®, may be applied before. The open channels remaining below such a sealing sheet improve the heat distribution.
Once the tiling has been set and jointed, the mastic joint can be made.
Overall thickness of the entire system: 4.5 cm.
The entire sequence of operations can be carried out without any waiting times.

In FIGS. 4 through 7, an alternative design of a tool according to the invention is shown and depicted in total with reference numeral 30.

Herein, as also in the remaining following Figures, corresponding reference numerals are used for corresponding parts.

The tool 30 like the tool 20 previously explained with reference to FIG. 2, consists of a mounting section 12, a guiding section 6 connected to the mounting section 12 by a bent-off section, and of a hollow knife 9 received on the guiding section.

The mounting section 12 has an almost trapezoidal shape which is somewhat expanded into the direction of the guiding section 6 and has rounded corners. The tool receptacle 5 being designed as a mounting opening serves for connection with the output shaft of an oscillatory drive. The tool receptacle 5 is designed in the form of a multiple edge for effecting a positive connection with the output shaft (FIG. 12) of the oscillatory drive 42 which has a mated shape.

The guiding section or the sliding plate 6 has a roughly rectangular shape which leads into the mounting section 12 via a tapering and the bent-off. In the middle of the plate-shaped guiding section 6, a rectangular cutout 22 is formed through which the hollow knife 9 is inserted with two tongues 23 and is secured on both sides by means of five point weldings 24 Thus, a durable and rigid connection between the hollow knife 9 and the guiding section or the sliding plate 6 is formed. As in particular can be seen from FIG. 6, the hollow knife 9 protrudes from its both ends 13, 14 outwardly on the side of the guiding surface opposite the tongues 23 and comprises a roughly partially circular cutter, both end sections of which run straight into the cutout 22.

It will be understood that this shape of the cutter 9 is naturally merely of exemplary nature for one of many possible cross-sections which can be generated with the hollow knife 9, such as also rectangular or V-shaped cross-sections. V-shaped cross-sections are advantageous when cuts for bending lines for bending panels shall be generated (e.g. when laying from bottom to wall).

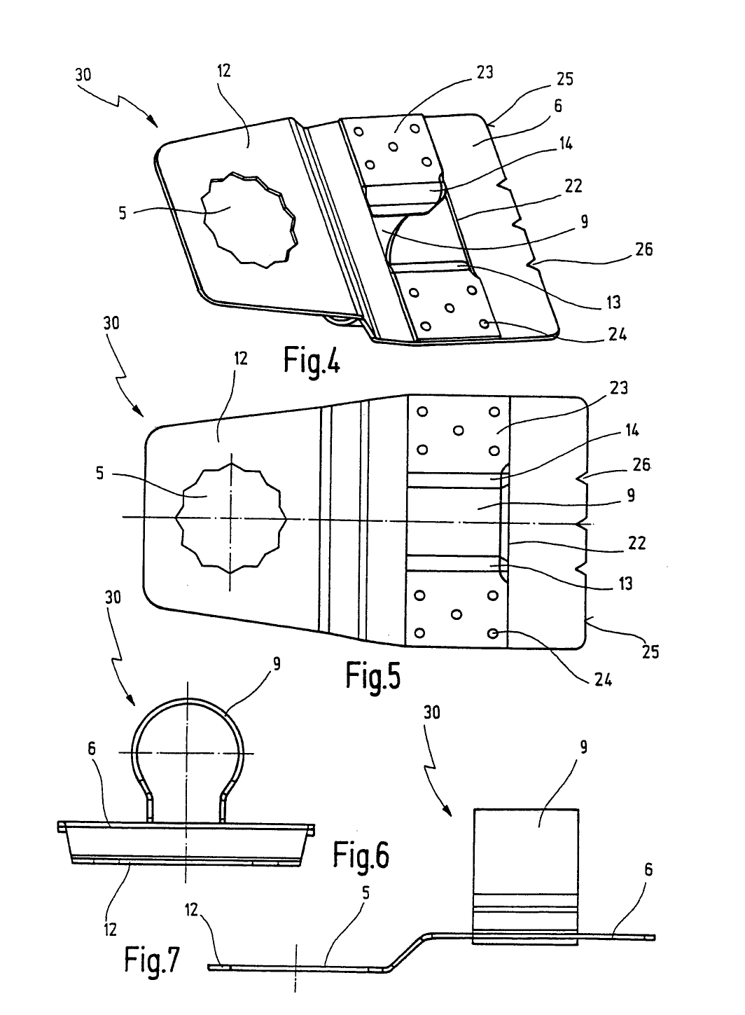

In FIGS. 4 and 5, in addition three markings 26 being designed as indentations can be seen on the front edge of the guiding section 6 opposite the mounting opening 5, which may help a user to guide the tool 30 along a pre-drawn marking.

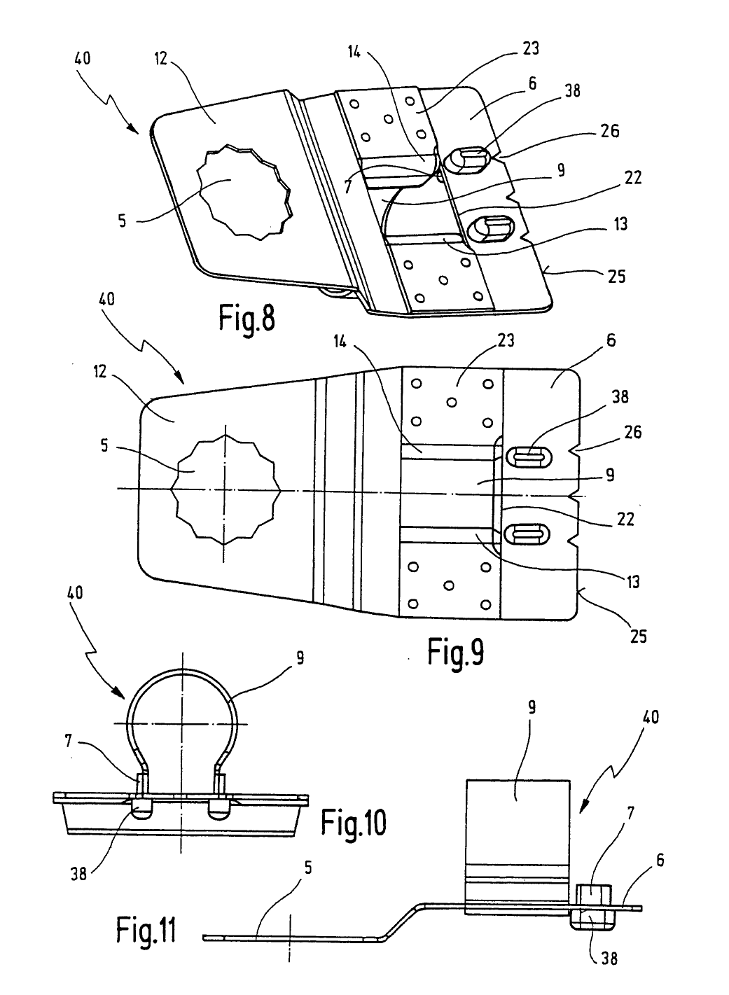

A modification of the tool according to the invention is shown in FIGS. 8 to 11 and designated in total with reference numeral 40.

The tool 40 largely corresponds to the tool 30 previously explained with reference to FIGS. 4 through 7. The single difference to the tool 30 rests in the fact that in addition two cutters 7 are received at the guiding section 6 which serve as pre-cutters for the hollow knife 9. The cutters 7 are arranged before the hollow knife 9 with respect to the feed direction. They serve to protect the hollow knife 9 against a too high wear-off and are, for instance, designed as hard alloy cutters. The cutters 7 are secured in cutouts on the guiding section and are fastened on the opposite side by a securing point 38 each, as can in particular be seen from FIG. 11. Securing can e.g. be achieved by a press-fit, a welding or the like.

In the following, with reference to FIG. 12 it will be explained how the tool according to the invention can be used in combination with an oscillatory drive 42 for cutting surface channels in plate-shaped workpieces.

In FIG. 12, an oscillatory drive of known design which, e.g., is marketed by the applicant, is depicted with reference numeral 42. The oscillatory drive 42 comprises an output shaft 43 at the outer end of which a positive fit piece (not shown) is provided for effecting a positive fit with the mounting opening 5 of the tool 30. The tool 30, as shown in FIG. 12, is placed with its mounting opening 5 onto the positive-fit piece and is secured from the outside against loosening by a nut 44. The output shaft 43 of the oscillatory drive 42 is driven in pivot motions about the longitudinal axis 45 of the output shaft 43, as indicated by double arrow 46. The oscillations may, e.g., be performed at a frequency of 15,000 oscillations per minute and at a pivot angle of about 0.5 to 3°. Thereby, the hollow knife 9 of the tool 30 is driven in oscillations which are roughly perpendicular to its cutter. Now, the tool 30 can be pushed through the workpiece in feed direction 47, whereby the advancing force is transmitted via the oscillatory drive 42 directly onto the hollow knife 9 in radial direction of the longitudinal axis 45.

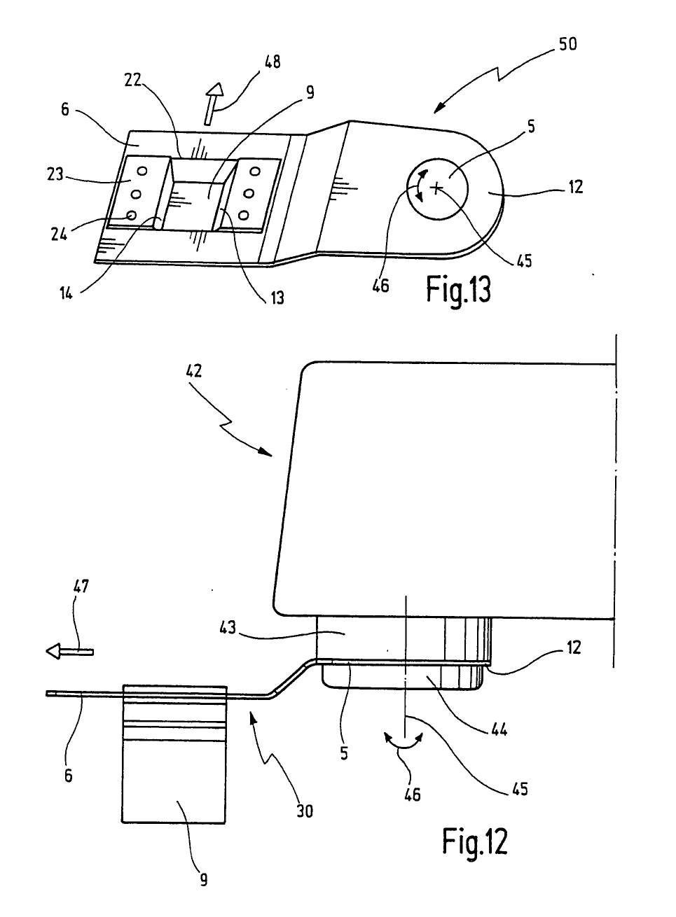

An alternative design of the tool according to the invention is shown in FIG. 13 and depicted in total with reference numeral 50.

Herein, the mounting of the tool 50 at its mounting section 12 is not performed like the embodiment according to FIG. 12 in a pretended extension of the feed direction 47, instead, a lateral securing is provided. Again, the mounting section 12 comprises a mounting opening 5 which, preferably, is shaped as a multiple edge, however, is shown here merely circular. The hollow knife 9 now is received at the cutout 22 of the guiding section 6 rotated by 90° with respect to the embodiment according to FIG. 12, so that the cutter of the hollow knife 9 points laterally, as can be seen in FIG. 13. Thus, a feed direction 48 results which is roughly in parallel to a tangent of the longitudinal axis 45 of the mounting opening 5 by which the tool 50 is secured to the output shaft 43.

Thus, according to this design, the oscillations occur roughly in feed direction 48 going back and forth, while with the embodiment according to FIG. 12, the oscillations occur perpendicularly to the feed direction 47.

With the design according to FIG. 13, the tool 50 thus is held laterally alongside the hollow knife 9 by means of the oscillatory drive 42 and can be pushed through the work-piece or drawn through the workpiece. The oscillatory motions itself contribute to the cutting effect, since these work in feed direction and thus serve to aid the cutting process. However, differently from the embodiment according to FIG. 12, here a lateral lever force is generated which must be borne by the user.

What is claimed is:

1. A tool for generating surface channels in plate-shaped workpieces, comprising
a fastening section having a tool receptacle for securing the tool to an oscillatory drive;
a guiding section configured plate-shaped for guiding the tool along a surface of the workpiece;
a hollow knife having at least one cutting edge and comprising a first end and a second end, wherein said first and second ends each are rigidly connected with said guiding section.

2. The tool of claim 1, wherein said first and second ends of said hollow knife are each connected with said guiding section by a solid material.

3. The tool of claim 2, wherein said first and second ends are welded to said guiding section.

4. The tool of claim 1, wherein said hollow knife is configured in a certain shape the of the cross-section of which is mated to the cross-section of a surface channel to be produced.

5. The tool of claim 4, wherein said hollow knife comprises a cutting edge having at least one section which is selected from the group formed by a straight section and a bent section.

6. The tool of claim 5, wherein said cutting edge has a cross-section substantially having a shape which is selected from the group formed by a partially circular shape, a rectangular shape and a V-shape.

7. The tool of claim 1, wherein said guiding section opposite said fastening section comprises a front edge, said front edge comprising at least one mark.

8. The tool of claim 1, wherein said guiding section comprises a cutout through which said hollow knife is inserted within the region of its first and second ends and is secured to the guiding section on a side opposite the hollow knife.

9. The tool of claim 1, wherein said hollow knife is secured to the guiding section on a side facing the guiding section.

10. The tool of claim 9, wherein said guiding section is configured as a continuous plate without any cutout.

11. The tool of claim 1, comprising at least one additional cutter being secured to said guiding section.

12. The tool of claim 11, wherein said additional cutter is configured as a hard alloy cutter and protrudes beyond said hollow knife within a working direction of said tool.

13. The tool of claim 1, further comprising a wear-resistant protective layer.

14. The tool of claim 13, wherein said protective layer comprises at least one selected from the group formed by hard metal particles, diamond particles and boron carbide particles.

15. The tool of claim 1, wherein said tool receptacle is configured as a mounting opening for securing the tool to an oscillatory drive, said mounting opening defining a longitudinal axis about which the tool can be oscillatingly driven;
wherein said hollow knife defines a feed direction which is substantially radial to said longitudinal axis.

16. The tool of claim 15, wherein said guiding section comprises a cutout through which said hollow knife is inserted within the region of its first and second ends and is secured to the guiding section on a side opposite the hollow knife.

17. The tool of claim 16, wherein said first and second ends are welded to said guiding section.

18. A tool for generating surface channels in plate-shaped workpieces, comprising:
a fastening section having a mounting opening for securing the tool to an oscillatory drive, said mounting opening defining a longitudinal axis about which the tool can be oscillatingly driven;
a guiding section for guiding the tool along a surface of a workpiece;
a hollow knife having at least one cutting edge;
wherein said hollow knife defines a feed direction which is arranged at an angle to said longitudinal axis.

19. The tool of claim 18, wherein said feed direction extends substantially radially to said longitudinal axis.

20. A tool for generating surface channels in plate-shaped workpieces, said tool comprising:
a fastening section having a mounting opening for securing the tool to an oscillatory drive, said mounting opening defining a longitudinal axis about which the tool can be oscillatingly driven;
a guiding section for guiding the tool along a surface of a workpiece;
a hollow knife having at least one cutting edge;
wherein said hollow knife defines a feed direction which is arranged in parallel to a tangent of said longitudinal axis.
